(19) United States
(12) Patent Application Publication
(10) Pub. No.: US 2014/0304187 A1
(43) Pub. Date: Oct. 9, 2014

(54) SYSTEM AND METHOD FOR MAKING A CONTEXT-SENSITIVE DONATION

(71) Applicant: HOPELA, BELLEVUE, WA (US)

(72) Inventor: IRINA N. MENN, BELLEVUE, WA (US)

(73) Assignee: HOPELA, BELLEVUE, WA (US)

(21) Appl. No.: 14/217,171

(22) Filed: Mar. 17, 2014

Related U.S. Application Data
(60) Provisional application No. 61/799,668, filed on Mar. 15, 2013.

(51) Int. Cl. G06Q 30/02

(52) U.S. Cl. CPC G06Q 30/0279
USPC 705/329

(57) ABSTRACT

A mobile device application includes computer-executable instructions configured to determine a donation context, and to select from among a plurality of non-profit organizations (NPOs) or charitable campaigns for receiving a donation from a user of the mobile device. In one embodiment, a machine-readable symbol decoder configured to extract scan-to-give data from a scanned scan-to-give symbol. The scanning of the scan-to-give symbol can initiate a charitable contribution.

### CROSS-REFERENCE TO RELATED APPLICATIONS

The present application claims priority benefit from U.S. Provisional Patent Application No. 61/799,668, entitled “SYSTEM AND METHOD FOR SCANNING A SYMBOL TO MAKE A CHARITABLE CONTRIBUTION”, filed Mar. 15, 2013; which, to the extent not inconsistent with the disclosure herein, is incorporated by reference.

### SUMMARY

There is a need to enable persons to make a charitable contribution at a moment of inspiration. Furthermore, there is a need to allow non-profit organizations (NPOs), also referred to herein as charities or charitable causes, easier access to the donors. Small NPOs, in particular, cannot afford to solicit donations that otherwise would be freely given. There is also a need to allow NPOs to enjoy some of the benefits of “viral” marketing, whereby the Internet generally, and social media particularly, can multiply an effective message. Finally, high transaction costs can limit the ability for charitable organizations to reach out to request or to receive charitable donations from individuals and limits the effectiveness of small donations. It is desirable to provide a method and system to allow charitable organizations to address these and other needs.

According to an embodiment, a method for making a context-sensitive donation to a non-profit organization (NPO) includes receiving user-initiation of a charitable donation software application on a mobile computing device via a user interface (UI) (for example, by receiving a user-activation of an application icon on a graphical user interface (GUI)). Mobile device hardware (e.g., smart phone camera(s), radio circuit(s), and other sensing hardware) is operated to obtain donation context data. A charitable campaign corresponding to the donation context data is identified. A charitable campaign profile is displayed to the user on a graphical display of the mobile device. A user may issue a command via the UI to make a donation. The donation is automatically processed responsive to the user command.

According to an embodiment, a system for context-sensitive donation to a NPO includes a mobile device. The mobile device includes a microprocessor and a computer memory operatively coupled to the microprocessor and configured to cooperate with the microprocessor to collectively execute computer instructions. A radio circuit includes at least one radio operatively coupled to the microprocessor and configured to communicate with a data network. A graphical display is operatively coupled to the microprocessor and configured to display graphical images responsive to microprocessor instructions. A UI is operatively coupled to the microprocessor and configured to receive user commands and output corresponding user command data for execution by the microprocessor. In preferred embodiments, the graphical display and the UI are formed at least partially from a touch screen display that forms a GUI. The computer memory carries instruction data corresponding to a mobile software application for making a context-sensitive donation when the microprocessor executes the instruction data. The mobile software application includes instructions selected to cause the microprocessor to obtain donation context data, identify a charitable campaign responsive to the donation context data, display a charitable campaign profile to the user on the graphical display, receive a command from the user via the UI to donate, and process the donation.

Optionally, a mobile browser can be used to access application functions described herein. The mobile browser presents UI elements described herein and can, if enabled, access mobile device hardware to determine donation context.

According to an embodiment, a system for context-sensitive donation to a NPO includes a mobile device with a microprocessor and a computer memory operatively coupled to the microprocessor and configured to cooperate with the microprocessor to execute computer instructions. A radio circuit including at least one radio operatively coupled to the microprocessor and configured to communicate with a data network. A graphical display is operatively coupled to the microprocessor and configured to display graphical images responsive to microprocessor instructions. A UI is operatively coupled to the microprocessor and configured to receive user commands and output corresponding user command data for execution by the microprocessor. The computer memory carries instruction data corresponding to a mobile software application for making a context-sensitive donation when the microprocessor executes the instruction data. The mobile software application includes instructions selected to cause the microprocessor to obtain donation context data, transmit the donation context data to a server computer operatively coupled to the data network, and receive data corresponding to one or more charitable campaign profiles associated with the context data by the server computer. A charitable campaign profile is displayed to the user on the graphical display. A command can be received from the user via the UI to donate and the donation is processed.

According to an embodiment, a non-transitory computer readable medium carrying instructions is selected to cause a mobile device to execute steps including receiving user-initiation of a charitable donation software application on a mobile computing device via a UI, operating mobile device hardware to obtain donation context data, and identifying a charitable campaign responsive to the donation context data. A charitable campaign profile is displayed to the user on a graphical display of the mobile device. A command is received via the UI to donate and a donation is processed.

According to an embodiment, a context object carrying context data for charitable donation, includes a surface carrying a logotype selected for user identification of the context object, and a portable data carrier configured for interrogation by a mobile device and carrying non-transitory computer-readable data structured for use by a mobile application as context data for identifying one or more charitable campaigns for receiving a donation.

According to an embodiment, a context object carrying context data for charitable donation, includes a surface carrying a logotype selected for user identification of the context object. A portable data carrier is configured for interrogation by a mobile device and carries non-transitory computer-readable access data structured for use by a mobile application to access context data on a server computer. The context data identifies one or more charitable campaigns for receiving a donation.

According to an embodiment, a donation server computer includes a non-transitory computer-readable medium carrying instructions selected to cause the donation server to receive donation context data from a mobile device via a network, determine one or more NPOs and/or one or more charitable campaigns that correspond to the donation context data, and transmit the identity(ies) of the one or more NPOs and/or one or more charitable campaigns to the mobile device via the network.

According to an embodiment, a method for scanning a bar code symbol to initiate a charitable event includes scanning a machine-readable symbol including a scan-to-give data field. A user/donor receives a giving event object abstraction linked to the scan-to-give data field and is presented with a GUI including the giving event object abstraction. The GUI receives a user input. A server application processes the giving event corresponding to the scan-to-give and causes a fund transfer from the donor to a designated charitable organization.

According to an embodiment, a non-transitory machine-readable medium can carry computer executable instructions configured to cause one or more computers to execute steps including scanning a machine readable scan-to-give symbol carrying scan-to-give data to initiate a charitable event, presenting to a user a giving event object abstraction linked to the scan-to-give data field as part of a GUI including the giving event object abstraction. The GUI receives a user input. A server application processes the giving event corresponding to the scan-to-give and causes a fund transfer from the donor to a designated charitable organization

According to another embodiment, a system for charitable event processing includes a plurality of end devices configured to scan scan-to-give bar code symbols including scan-to-give data. A network is configured to convey the scan-to-give data and user identification or end device identification to a server. The server includes an application configured to receive the scan-to-give data and user or end device identification, associate the scan-to-give data with a user account, and execute or cause to be executed an account transfer from the user to a charitable organization selected by the user or included in the giving event tracking data. The system can further accrue plural scan-to-give events. The system can provide an end-of-year statement to the user with a record of charitable contributions.

### BRIEF DESCRIPTION OF THE DRAWINGS

FIG. 1 is a flowchart illustrating a method for making a context-sensitive donation to a non-profit organization (NPO), according to an embodiment.

FIG. 2 is a diagram of a system for context-sensitive donation to a NPO, according to an embodiment.

FIG. 3 is a flowchart or presenting a graphical user interface (GUI) to a user of a mobile device for making a context-sensitive donation to an NPO using the mobile device, according to an embodiment.

FIG. 4 is a diagram of an illustrative mobile device splash screen or home screen of a mobile application for making a context-sensitive donation to a NPO, according to an embodiment.

FIG. 5 is a diagram of an illustrative mobile device sign-up screen, according to an embodiment.

FIG. 6 is a diagram of an illustrative mobile donation context mode selection screen, according to an embodiment.

FIG. 7 is a diagram of an illustrative mobile device location-based donation context screen, wherein location-based donation context is displayed, according to an embodiment.

FIG. 8 is a diagram of an illustrative mobile device search results screen, wherein candidate NPOs and/or campaigns are displayed to a user, according to an embodiment.

FIG. 9 is a diagram of an illustrative mobile device NPO or campaign profile screen, according to an embodiment.

FIG. 10 is a diagram of an illustrative mobile device donation screen 1000, according to an embodiment.

FIG. 11 is a diagram of an illustrative mobile device thank you screen, according to an embodiment.

FIG. 12 is an illustration of an example of a context object carrying context data for charitable donation, according to an embodiment.

FIG. 13 is a flow chart showing a method for scanning a machine-readable scan-to-give symbol to initiate a charitable giving event, according to an embodiment.

FIG. 14 is a diagram of a system for charitable event processing, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

Non-profit organizations, also referred to as NPOs, generally provide support for societal needs that are not met by government and for which individuals are unable or ill suited to pay for directly. For example, NPOs can have cultural, religious, educational, environmental, or human needs orientations. Some NPOs can be classified under more than one category and other NPO's may be defined otherwise.

The term “non-profit organization” is used according to its normal meaning. “NPO” is used as an acronym synonymous with “non-profit organization.” U.S. Tax Codes define particular requirements of an NPO.

“Donation” means a gifting of money or other thing of value to an NPO. “Charitable donation” may be regarded as synonymous with “donation.” “Charitable gift” or, more compactly, “gift” may also be regarded as synonyms of “donation.”

A “charitable campaign”, or more compactly “campaign” refers to a fund-raising program by an NPO. Frequently, NPOs run particular campaigns to raise money for particular uses. For example, after a disaster, the American Red Cross™ may run a campaign to raise funds for relief efforts for recovery from the disaster. Other campaigns represent ongoing drives for general purpose fundraising. As used herein, the term “charitable campaign” is intended to span the entire range of NPO fundraising efforts. The term “giving opportunity” may be considered synonymous with “charitable campaign”.

“Context” refers to a detectable aspect of an environment the user and of a mobile computing device carried by the user. According to embodiments, “context” is used to uniquely identify or at least narrow a list of possible NPOs and/or possible charitable campaigns from a universe of possible NPOs and/or charitable campaigns. One purpose of context is to convey identity of one or more NPOs and/or charitable campaigns to a charitable donation software application. Context is used to infer a user's intent with respect to a prospective donation, particularly with respect to presenting the NPO or campaign to the user for solicitation of a donation.

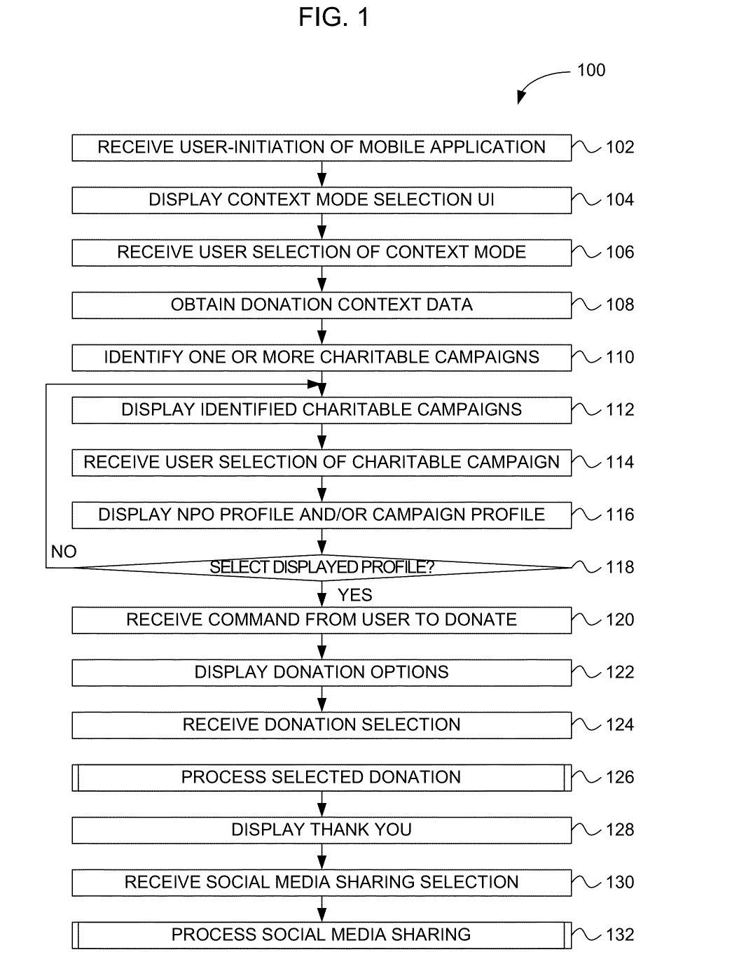

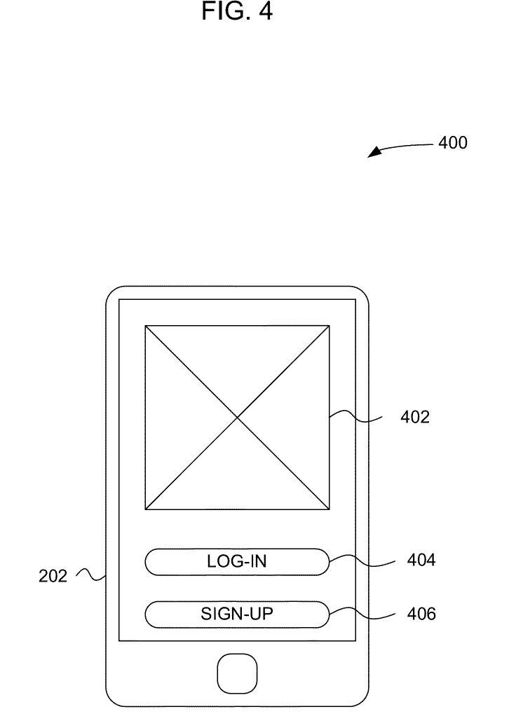

FIG. 1 is a flow chart illustrating a method 100 for making a context-sensitive donation to an NPO, according to an embodiment. The method 100 begins at step 102, wherein user-initiation of a charitable donation software application on a mobile computing device via a UI is received (for example, by receiving a user-activation of an application icon on a graphical GUI). The user-initiation can also include logging in to a mobile application. FIG. 4 is a diagram of a GUI screen embodiment 400 that displays a log-in control.

Referring again to FIG. 1, proceeding to step 108, mobile device hardware is operated to obtain donation context data. Continuing to step 110, a charitable campaign responsive to the donation context data is identified. In step 116, a charitable campaign profile is displayed to the user on a graphical display of the mobile device. Proceeding to step 120, a command is received via the UI to donate. In step 126 a donation is processed.

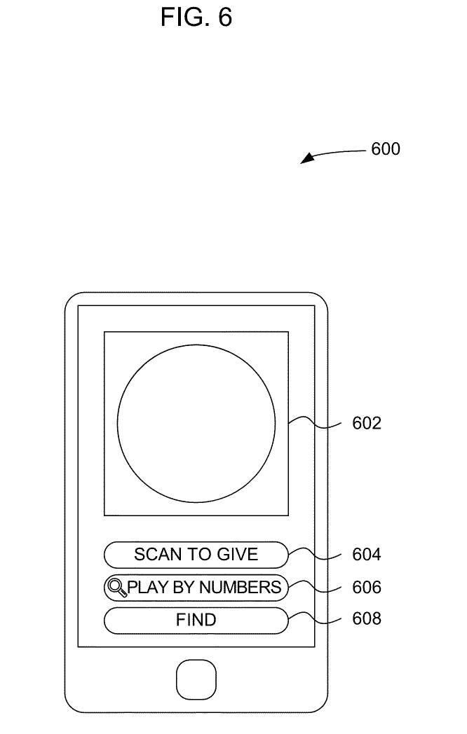

According to an embodiment, the method 100 can further include step 104, wherein a donation context mode selector is displayed on the graphical display of the mobile device. FIG. 6 is a diagram of a GUI screen embodiment 600 that displays a mode selector for determining donation context.

Referring again to FIG. 1, proceeding to step 106, user selection of the donation context mode via the UI is received. For example, (referring briefly to FIG. 6) one of the GUI objects 604, 606, or 608 can be selected by the user. Proceeding to step 108, the mobile device hardware is operated to obtain the donation context data including operating mobile device hardware corresponding to the user-selected mode.

Step 108, operating the mobile device hardware, can include executing computer instructions, capturing an image of physical indicia carrying the context data and/or operating one or more radios to obtain location data. The location data can be at least a portion of the context data.

Step 108 can include operating a near field communication (NFC) apparatus to receive NFC data. The context data can be carried by (included in) the NFC data, for example.

Step 108 can include reading a mobile device clock circuit to determine a time and look up the context data corresponding to the time.

In an embodiment, step 108 operating the mobile device hardware can include operating one or more radios to interrogate a radio frequency tag, and writing radio frequency tag data to memory. The context data can be carried by (is included in) the radio frequency tag data.

Referring to step 110, identifying a charitable campaign responsive to the donation context data can further include transmitting the context data to a remote resource via radio transmitter hardware of the mobile device, and receiving an identity of the charitable campaign from the remote resource via radio receiver hardware of the mobile device.

In step 110, identifying a charitable campaign responsive to the donation context data can further include constructing a database query including the donation context data, performing a database search with the database query, and receiving a query result including one or more charitable campaigns. In one embodiment, the donation context data can be transmitted to a donation server, whereupon the database query is performed on the donation server. In another embodiment, the database query is performed on a campaign database carried by a memory circuit of the mobile device.

Step 110 can further include inputting the context data into a lookup table carried by memory hardware of the mobile device and receiving an identity of the charitable campaign from the lookup table.

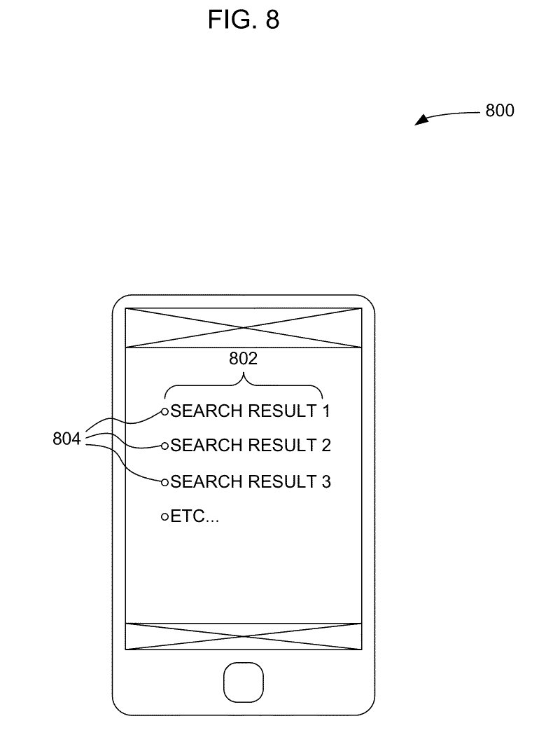

Step 110 can further include identifying a plurality of charitable campaign candidates corresponding to the context data. The method 100 can further include step 112 wherein the plurality of charitable campaign candidates are displayed on the graphical display of the mobile device. FIG. 8 is a diagram of a GUI screen embodiment 800 that displays a plurality of charitable campaign candidates to the user.

Referring again to FIG. 1, proceeding to step 114, selection of one or more of the charitable campaign candidates can be received from a user via the UI.

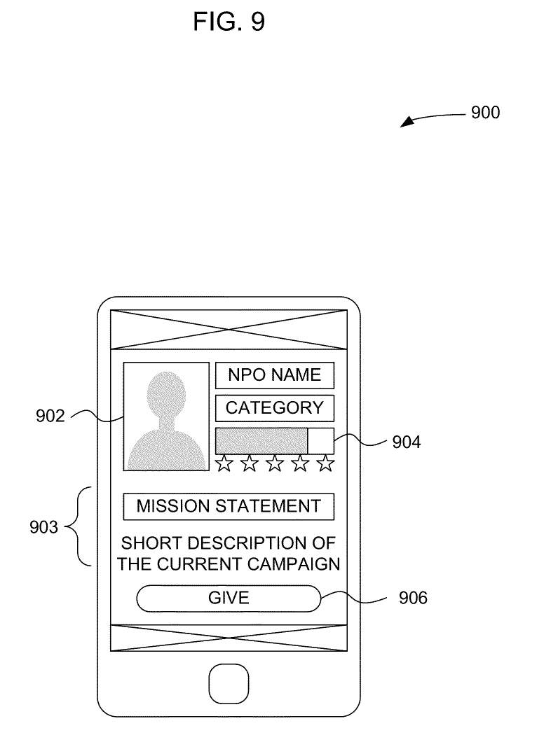

Continuing to step 116, a campaign profile including displaying an NPO profile can be displayed. Displaying a campaign profile can include displaying a profile predetermined by a particular NPO that benefits from a donation to the campaign. FIG. 9 is a diagram of a GUI screen embodiment 900 that displays a campaign profile to the user.

Referring to FIG. 1, steps 112, 114, 116, and 118 illustrate a loop wherein a sequence of campaign profiles corresponding to a plurality of identified charitable campaigns is presented to the user on the graphical display of the mobile device. The user can review the plurality of identified charitable campaigns and select from among the charitable campaigns.

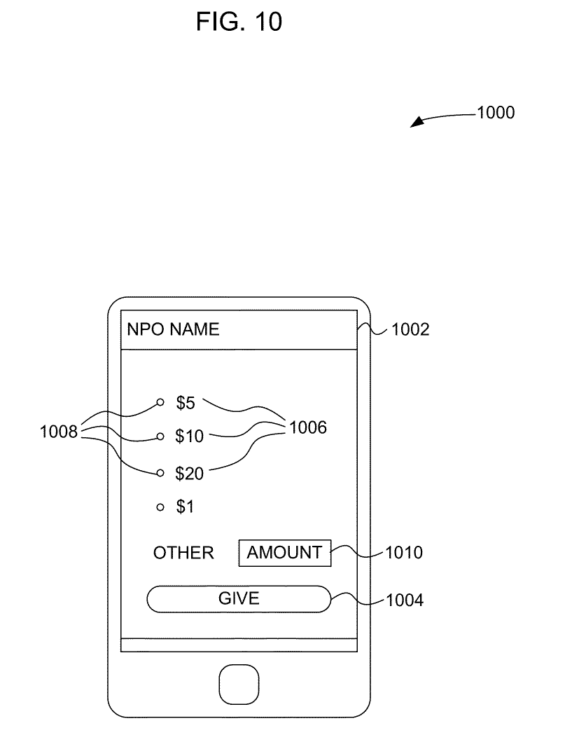

Proceeding to step 122, donation options are displayed to the user on the graphical display of the mobile device. FIG. 10 is a diagram of a GUI screen embodiment 1000 that displays donation options to the user.

Referring again to FIG. 1, proceeding to step 124, a donation selection is received from the user via the UI. Continuing to step 126, the donation is processed including processing the selected donation. The donation processing can be performed by transmitting data corresponding to a selected donation from the mobile device to a donation transaction server via cryptographic protocol communication. Step 126 can include charging the donation to a credit card associated with the user on a secure server, charging the donation to an Internet purchase account (e.g., PAYPAL (R)), debiting a bank account associated with the user, and/or debiting a cryptographic currency wallet. Step 126 can include crediting an account of the NPO associated with the campaign.

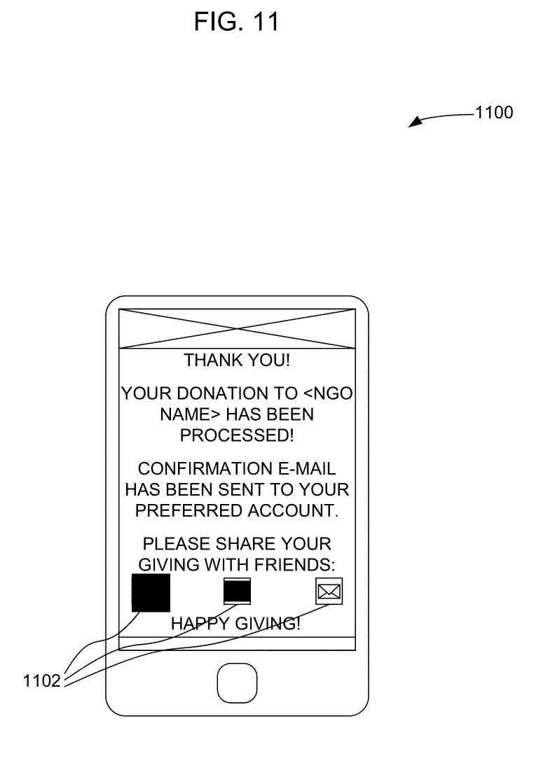

The method 100 can further include step 128 wherein a thank you screen is displayed to the user on the graphical display of the mobile device. FIG. 11 is a diagram of a GUI screen embodiment 1100 that displays a thank you to the user. Step 128 can include displaying a social media sharing selection on the thank you screen 1100.

Referring to FIG. 1, proceeding to optional step 130, a social media sharing selection can be received from the user via the UI of the mobile device. Proceeding to optional step 132, the selected social media sharing can be processed to share information about the donation. Sharing donation information (e.g., identifying the campaign and indicating that the user made an unspecified donation to the campaign) can help solicit more donations to the campaign.

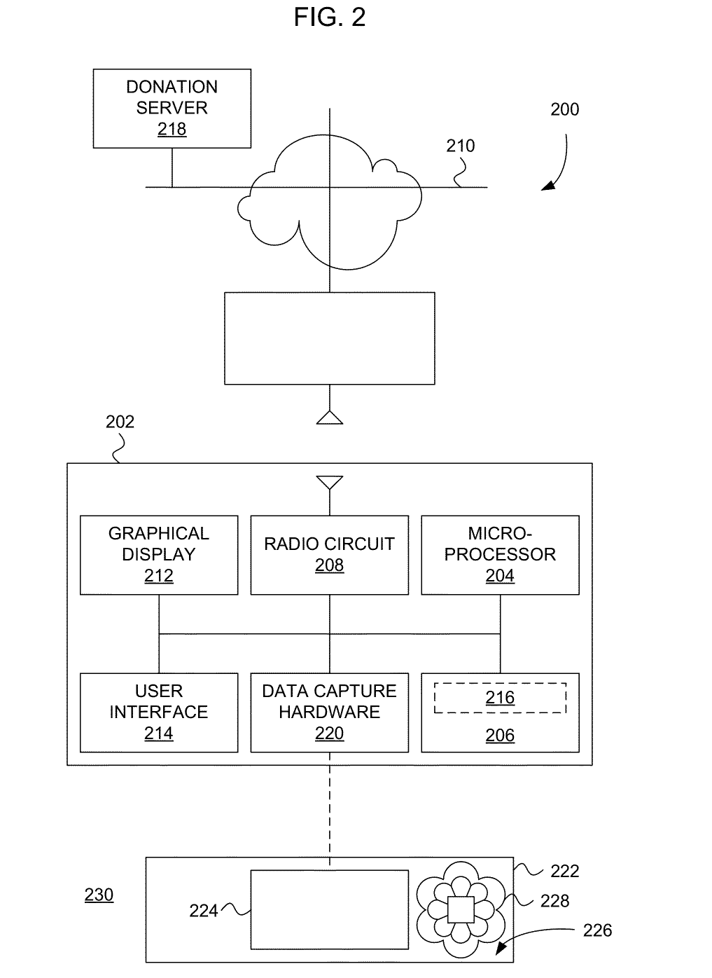

FIG. 2 is a diagram of a system 200 for context-sensitive donation to a NPO, according to an embodiment. The system 200 includes a mobile device 202 including a microprocessor 204. A computer memory 206 is operatively coupled to the microprocessor 204 and configured to cooperate with the microprocessor 204 to execute computer instructions. A radio circuit 208 includes at least one radio operatively coupled to the microprocessor 204 and configured to communicate with a data network 210. A graphical display 212 is operatively coupled to the microprocessor 204 and configured to display graphical images responsive to microprocessor 204 instructions. A UI 214 is operatively coupled to the microprocessor 204 and configured to receive user commands and output corresponding user command data for execution by the microprocessor 204. The graphical display 212 and the UI 214 can optionally be combined as a GUI.

The computer memory 206 carries instruction data corresponding to a mobile software application 216 for making a context-sensitive donation when the microprocessor 204 executes the instruction data. In other words, the mobile software application 216 is carried by the computer memory 206 as computer instructions configured for execution by the microprocessor 204. According to an embodiment, the mobile software application 216 includes instructions selected to cause the microprocessor 204 to obtain donation context data, identify a charitable campaign responsive to the donation context data, display a charitable campaign profile to the user on the graphical display 212, receive a command from the user via the UI to donate, and process the donation.

According to an embodiment, the system 200 can further include a server computer 218 operatively coupled to the data network 210 and configured to cooperate with the mobile device 202 to make the context-sensitive donation.

The mobile device 202 can optionally include data capture hardware 220 configured to interrogate a context object 222. In an embodiment wherein the context object 122 provides or enables provision of the donation context, the computer memory 206 holds instructions selected to cause the microprocessor 204 to operate the data capture hardware 220 to capture the context data from the context object 222. The data capture hardware 220 can include one or more of a camera and/or a portion of the radio circuit 208.

According to an embodiment, the system 200 can further include a context object 222, deployed for interrogation by the mobile device 202. The context object 222 can carry a portable data carrier 224 including physical pattern corresponding to the context data. The physical pattern can include a bar code symbol, an image having a class-unique shape, an instance-unique shape, and/or a (pattern matched) searchable image, for example. The context object 222 can carry a portable data carrier 224 carrying the context data. The portable data carrier 224 can include a bar code symbol, a radio frequency tag, and/or an NFC node. The context object 222 can further include a surface 226 carrying a logotype 228 selected to alert a user of a presence of the context object 222 in an environment 230.

In an embodiment, the context object 222 effectively gives the NPO a point of presence in the user's environment 230. Examples of context objects can include a magazine, and particularly a magazine ad; a direct mail solicitation; a label; etc.

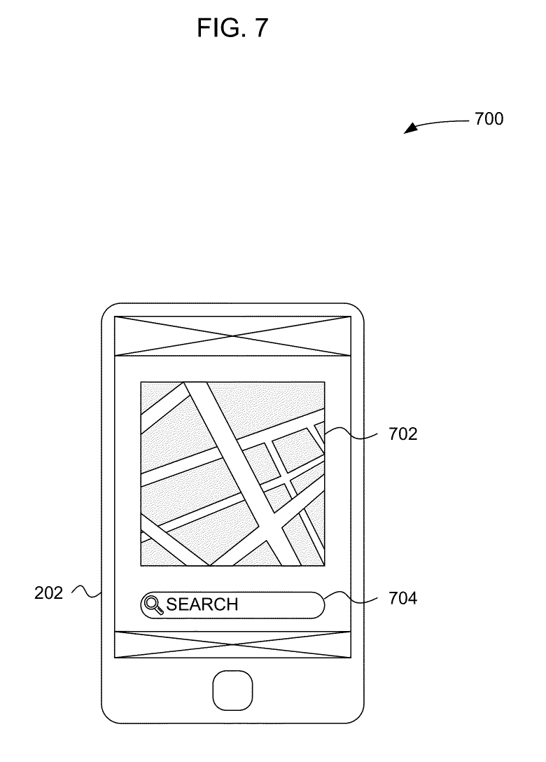

In another embodiment, the user's location (more precisely, the mobile device's location) provides the context. For example, the user's location can correspond to a physical location of an NPO. FIG. 7 is a diagram of a GUI screen embodiment 700 that displays a location to the user on a map window 702.

Referring again to FIG. 2, the mobile device 202 can include a location services module (e.g., a hardware/software complex that is capable of estimating a particular location 230 of the mobile device 202). For example, the location services module can estimate location based on known or inferred locations of WiFi (e.g., IEEE 802.11) networks that are detected by the radio circuit 208. The location services module can additionally or alternatively include a global positioning system (GPS) receiver that is configured to estimate location from a comparison of times at which signals from GPS satellites are received.

The memory circuit can carry context data configured to be addressed by location data from the location services module. The mobile device 202 can be configured to run computer instructions selected to address a context data portion of the memory circuit 206 and receive the context data on corresponding data lines. The memory circuit 206 can include one or a plurality of physical devices.

According to an embodiment, the computer memory 206 carries instruction data corresponding to a mobile software application 216 for making a context-sensitive donation when the microprocessor 204 executes the instruction data. The mobile software application 216 can include instructions selected to cause the microprocessor 204 to obtain donation context data, transmit the donation context data to a server computer 218 operatively coupled to the mobile device 202 via a data network 210, and receive data corresponding to one or more charitable campaign profiles associated with the context data by the server computer 218. A charitable campaign profile can be displayed to the user on the graphical display 212 (e.g., see FIG. 9 900). A command can then be received from the user via the UI to donate and the donation processed.

The context data can include location data corresponding to a particular location 230 of the mobile device 202. Additionally or alternatively, the context data can include data carried by a portable data carrier 224 available in an environment 230 of the mobile device 202. The context data can include structured data.

The donation context can correspond to proximity of the mobile device 202 to NPO collateral material. The mobile device 202 can include hardware configured to capture the donation context data when the mobile device 202 is proximate to the NPO collateral material. The donation context data can be carried by the NPO collateral, or alternatively a portable data carrier 224 operatively coupled to the NPO collateral material can carry data selected to direct a query to the context data when the portable data carrier 224 data is transmitted to the server computer 218.

In an embodiment, the donation context data can include location data. Obtaining the charitable-giving context data can include operating a location services module of the mobile device 202 and the charitable-giving context can correspond to a location 230 associated with an NPO. The location 230 associated with the charitable organization can include a point of presence of the charitable organization and/or a location of a charitable event.

Optionally, the mobile application can provide feedback related to location to the user via the graphical display 212. FIG. 7 is a diagram of a GUI screen embodiment 700 that displays location feedback to the user. Referring again to FIG. 1, obtaining donation context data in step 108 can include displaying location feedback to the user as shown in FIG. 7.

Referring again to FIG. 2, donation context data can take several forms. For example, the donation context data can include an identifier of an NPO that is non-volatile. Alternatively, the donation context data can include an identifier that is linked to an NPO via a database lookup in a donation server computer 218 or in the mobile device memory 206. In this way, a context object 222 can refer to different campaigns and/or different NPOs depending association of the data carried by the context object by the donation server computer 218. Similarly, for embodiments where context data corresponds to location, the location can be always linked to a particular NPO and/or campaign, or the location can be dynamically assigned to a particular NPO and/or campaign by selecting a location-to-NPO or location-to-campaign relationship in the donation server computer 218 or in the mobile device memory 206.

A campaign can be an ongoing effort by an NPO, or alternatively can correspond to a particular fund-raising drive by an NPO. The donation context data can uniquely correspond to a particular NPO and/or campaign by an NPO, or can correspond to a plurality of NPOs and/or campaigns.

The memory 206 can include computer instructions 216 selected to cause the microprocessor 204 to receive a context data mode selection from the user via the UI (e.g., see FIG. 6). Capturing the donation context data can include capturing and decoding the machine-readable symbol 224. Capturing the donation context data can further include converting decoded accessing the donation context data as a function of the captured and decoded machine-readable symbol 224 data. For example, the machine-readable symbol 224 can include a linear bar code symbol, a two-dimensional stacked symbol, or a two-dimensional matrix symbol. Examples of two-dimensional matrix symbols include QR Code and Data Matrix.

Receiving the context data mode selection from the user can include receiving a command to capture an image. Capturing the donation context data can further include capturing the image, converting the image to image data, and converting the image data to the donation context data.

Referring to FIG. 1, the method 100 can be embodied as a non-transitory computer readable medium (e.g. the memory 206 shown in FIG. 2) carrying computer executable instructions (e.g., 216 shown in FIG. 2) selected to cause a mobile device (e.g., 202 shown in FIG. 2) to execute the steps for making a context-sensitive donation to a NPO.

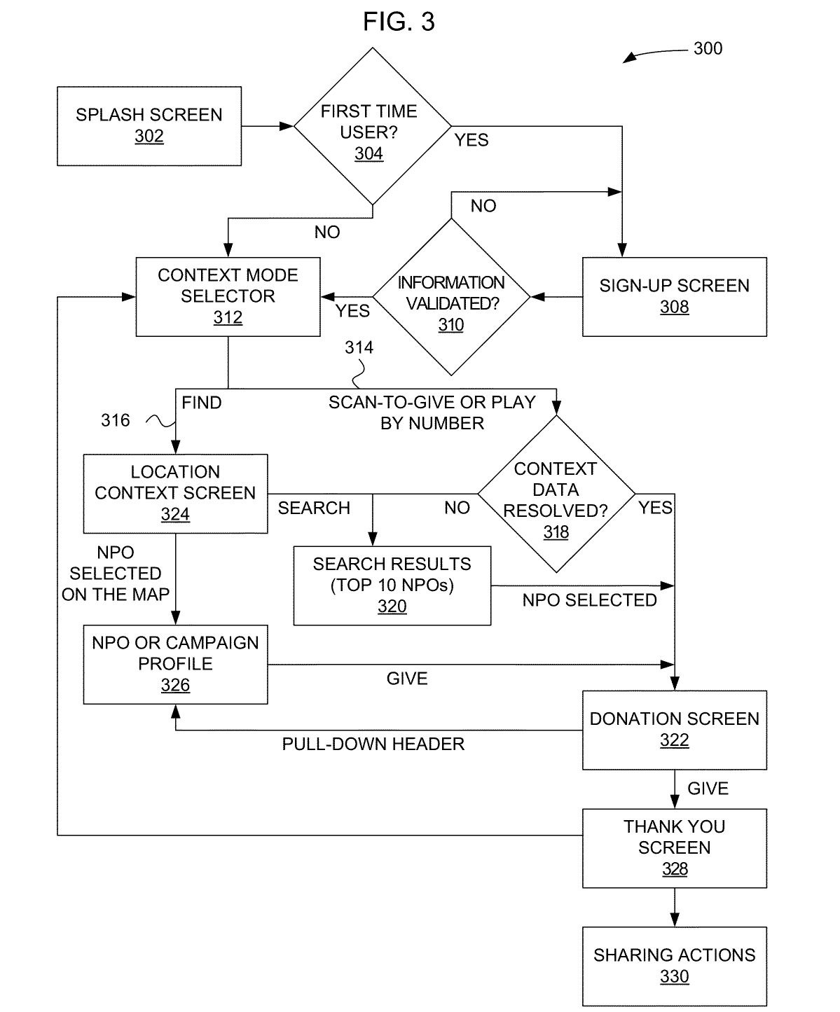

FIG. 3 is a flowchart 300 of a method for presenting a GUI to a user of a mobile device for making a context-sensitive donation to an NPO using the mobile device, according to an embodiment. The process 300 is typically initiated by receiving user selection of an icon on a mobile device screen (typically including a touch-sensitive interface for operating a GUI displayed on the screen). Upon receipt of program initiation, a splash screen can be displayed, as indicated by step 302.

FIG. 4 is a diagram 400 of an illustrative mobile device 202 splash screen 400 of a mobile application for making a context-sensitive donation to a NPO, according to an embodiment. The splash screen 400 can include a branded graphic 402. For example, the branded graphic 402 can include the logotype 228 to remind the user what to look for to find a the context object 222 (FIG. 2).

Referring to FIGS. 3 and 4, while displaying the splash screen 400 or in lieu of displaying a splash screen, the process proceeds to decision step 304, where the mobile device application determines if the application instance is associated with a user who is logged in. For example, if the application is minimized, then the method 300 can proceed from decision step 304 to step 312, wherein a context mode selector is displayed. The mobile application can optionally proceed directly to step 312 such that the context mode selector is the first screen displayed to the user. If the mobile application instance is associated with a user who is not logged in, then the user can select a LOG-IN control 404 to activate the application. After login (screen not shown) the process proceeds to step 312. If the user is a first time user, then the user can select a SIGN-UP control 406 to register the application instance (and the user) with a donation server (FIG. 2, 218). Upon receipt of a SIGN-UP command, the process 300 proceeds to step 308, wherein a sign-up screen is displayed.

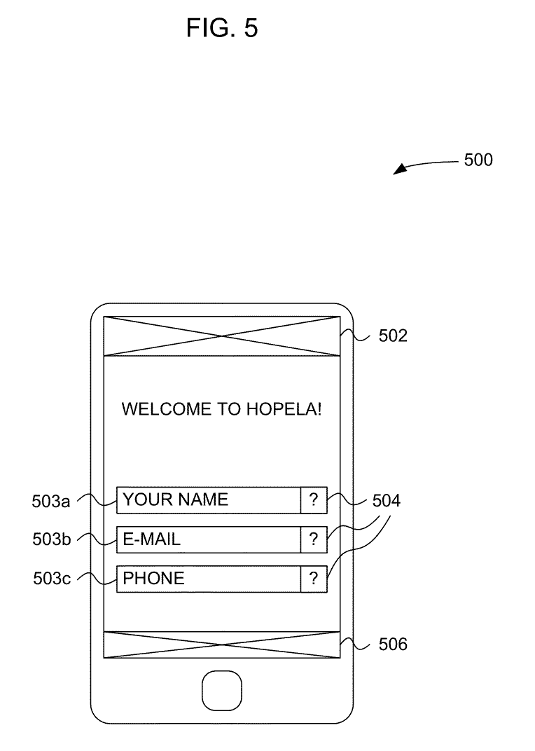

FIG. 5 is a diagram 500 of an illustrative mobile device sign-up screen 500, according to an embodiment. The sign-up screen 500 can include a graphic header 502, data entry fields 503a, 503b, 503c, help tips 504, and a standard footer 506. The standard footer 506 can include links to help, a profile and settling, for example. Sign-up can optionally include steps for entering credit card information, and or other information required to process a donation.

Referring again to FIG. 3, the process 300 proceeds to decision step 310, wherein the entered information is validated. Upon receiving validation (e.g., from a donation server 218, FIG. 2), the process proceeds to step 312.

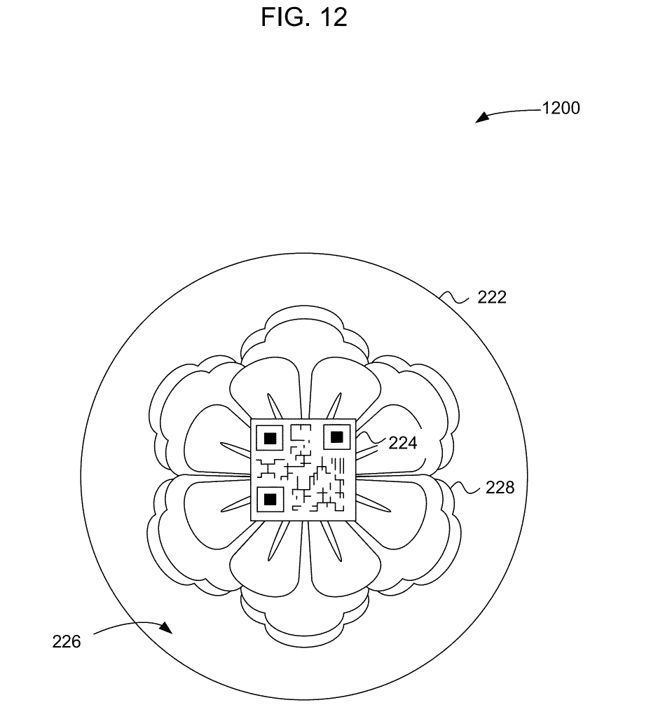

In step 312 a context mode selector screen is displayed. An illustrative context mode selector screen 600 is shown in FIG. 6. The context mode selector screen 600 can include a graphic image 602 that displays a logotype associated with the mobile donation application. An illustrative logotype is shown in FIG. 12. A SCAN TO GIVE control 604 activates a mobile device camera for capturing context data from a printed portable data carrier (224, FIG. 2). Optionally, the context mode selector screen 600 can include a NFC control (not shown) to enable capture of donation context data via NFC. Optionally, the user can tap the mobile device against an NFC-enabled second device, kiosk, node, etc. to cause the mobile application to attempt to receive donation context data via NFC. Optionally, the context mode selector screen 600 can include a RF TAG control (not shown) to enable capture of donation context data from a radio frequency tag. Optionally, the context mode selector screen 600 can include an AUTOMATIC control (not shown) to cause the mobile application to execute a search for donation context data across multiple possible context data sources and modalities. A PLAY BY NUMBERS control 606 activates a manual code entry screen (not shown) into which the user may type an NPO code and/or a campaign code. A FIND control 608 causes the mobile application to launch location-based donation context logic. Optionally, the mobile application may read location services data to detect location as soon as the user launches the application. If the mobile device (and user) location matches a known NPO or campaign location (at least at the time of application launch), the process 300 can jump from the splash screen 302 directly to step 326 (described below) wherein the NPO or campaign profile is displayed.

Referring again to FIG. 3, the process 300 can proceed along different paths depending on which context data mode is selected by the user (or if AUTOMATIC, by the mobile device application). For cases where object-related context is selected, such as when a SCAN TO GIVE control 604, NFC control (not shown), or RF TAG control (not shown) is selected by the user; or when the user selects the PLAY BY NUMBERS control 606, the process 300 proceeds along path 314 wherein the donation context data is obtained (e.g., step 108, FIG. 1) to decision step 318. For cases where location-related donation context is selected, such as when the FIND control 608 is activated by the user (or if AUTOMATIC, by the application), the process 300 proceeds along path 316 wherein location services is activated to step 324, wherein a FIND screen is displayed (e.g., see FIG. 7, described below).

Referring first to the object-related donation context path 314, the process proceeds to decision step 318 wherein the mobile application and/or a networked donation server computer (218, FIG. 2) determines if the obtained donation context data is resolved—i.e., if the received data is associated with a particular campaign and/or a particular NPO. If the donation context data is resolved, the process 300 can proceed directly to step 322, wherein a donation screen is displayed (e.g., see FIG. 10, described below). If the obtained donation context data is not resolved, the process 300 proceeds from decision step 318 to step 320, wherein a search results screen is displayed.

FIG. 8 is a diagram of an illustrative mobile device search results screen 800, wherein candidate NPOs and/or campaigns are displayed to a user, according to an embodiment. The search results screen includes a list 802 of NPOs and/or campaigns that correspond most closely to the obtained (unresolved) donation context data. Radio buttons operate as controls for the user to select one of the displayed NPOs and/or campaigns.

Referring again to FIG. 3, upon receiving user selection of a candidate NPO and/or campaign, the process 300 proceeds to step 322, described below. For cases where location-related donation context is selected, such as when the FIND control 608 on the donation context mode selector screen (600, FIG. 6) is activated by the user (or if AUTOMATIC, by the application) in step 312, the process 300 proceeds along path 316 wherein location services is activated to step 324, wherein a FIND screen is displayed.

FIG. 7 is a diagram of an illustrative mobile device location-based donation context screen 700, wherein location-based donation context is displayed, according to an embodiment. The location-based donation context screen 700 can display a map 702 showing a local environment of the mobile device 202 (and the user). Locations corresponding to NPOs are “pinned” on the map 702 to identify nearby locations corresponding to NPOs and/or campaigns. Optionally the find screen 700 can include an input text box 704 for inputting an NPO or campaign name. When an NPO or campaign name is received, the mobile application transmits a corresponding query to a donation server computer (218, FIG. 2), and the donation server computer downloads a map view corresponding to the input name.

In cases where a single NPO or campaign is displayed on the map, the user may acknowledge the correct NPO or campaign with a select control (not shown). In cases where the desired NPO or campaign is not shown on the map, the user may scroll the map by swiping or by activating a map magnification or scroll direction control (not shown) until the desired NPO or campaign shows up on the map view 702. In cases where a plurality of NPOs and/or campaigns are displayed on the map view, the user may select among them. For example, this can be done by scrolling a list (not shown) of NPOs (campaigns) until the desired NPO is shown. Optionally, the scrolled NPO pin on the map view is highlighted. Alternatively, the user may touch a pin on the map to select an NPO (campaign). With the find screen 700 activated (or optionally, minimized), the user may move around an area until a desired NPO is displayed on the map view 702. The user may proceed to the location indicated on the map. Optionally, turn-by-turn directions may be displayed and/or enunciated by the mobile application.

Referring to FIG. 3, upon selection of an NPO, the process 300 proceeds from step 324 to step 326, wherein an NPO or campaign profile is displayed.

FIG. 9 is a diagram of an illustrative mobile device NPO profile screen 900, according to an embodiment. The NPO profile screen 900 can display an NPO image 902 corresponding to a selected NPO (or campaign) and a mission statement 903. In one embodiment, the NPO image 902 and mission statement 903 are selected by the NPO, and the image 902 and mission statement 903 are provided by a donation server (218, FIG. 2). In another embodiment, the NPO image 902 and mission statement 903 are selected by a donation administrator, such as a company that provides the mobile application described herein. Optionally, the NPO profile screen 900 can include an NPO strength indicator 904. The strength indicator 904 can be compiled from user reviews and ratings of various NPOs. NPOs and campaigns can optionally be browsed by the user, for example by swiping the current NPO profile screen 900 to display a “next” or “previous” NPO or campaign profile 900. Using this approach, the user can compare NPOs and/or campaigns and select a particular cause that most appeals the values of the user. When a user has selected a desired charitable cause (i.e., and NPO and/or campaign), the user can activate a GIVE control 906 on the NPO profile screen 900.

Referring again to FIG. 3, receipt of a GIVE command causes the process 300 to proceed from step 326 wherein the NPO profile screen 900 is displayed to a step 322, wherein a donation screen is displayed.

FIG. 10 is a diagram of an illustrative mobile device donation screen 1000, according to an embodiment. The donation screen 1000 can include a pull down header 1002 configured to pull down an NPO profile screen 6. Activation of the pull down header 1002 causes the process 300 to proceed from step 322 to step 326. A give button 1004 is displayed to accept a user command to make a donation. Suggested donation amounts 1006 along with corresponding radio buttons 1008 can be used to select the desired donation amount. Optionally, the give screen can include a number entry field 1010 configured to receive user input of an amount different than (or the same as, for that matter) the suggested amounts 1006.

Optionally, the context data can encode a donation amount. In instances when the context data encodes a donation amount, the donation screen 1000 can be omitted.

Referring to FIG. 3, when the give control 1004 is selected, the selected donation is processed (e.g., see 126, FIG. 1), and the process 300 proceeds from step 322 to step 328, wherein a thank you screen is displayed to the user. During step 328, a confirmation email confirming the donation may also be sent to the user at the registered email address. Optionally, processing of the donation may be deferred until the user selects a link on the confirming email to complete payment. This approach can optionally be used in lieu of requesting and/or receiving payment information during step 308.

FIG. 11 is a diagram of an illustrative mobile device thank you screen 1100, according to an embodiment. Optionally, the thank you screen 1100 can include sharing controls 1102 for posting or emailing news of the donation to social media or selected persons.

Referring again to FIG. 3, upon receiving user activation of a sharing control 1102, the process 300 proceeds to step 330, where appropriate sharing actions are taken. The sharing actions can include posting a message about the donation on a social media public profile, can include sending an email notifying an employer of a matching donation, or can include sending an email to ask others to donate, for example.

As indicated above donation context can be obtained from various sources. According to embodiments, context data can be carried by a context object.

FIG. 12 an illustrative example 1200 of a context object 222 carrying context data for charitable donation, according to an embodiment. The context object 222 can include a surface 226 carrying a logotype 228 selected for user identification of the context object 222. A portable data carrier 224 can be configured for interrogation by a mobile device, and can carry non-transitory computer-readable data structured for use by a mobile application as context data for identifying one or more NPOs or charitable campaigns for receiving a donation.

The structured data can include a data field carrying the context data, a data identifier configured to identify a structure of the data field, and an application identifier configured to identify a structure of the data field. The structured data can include a tagged data field carrying the context data.

The portable data carrier 224 can include a bar code symbol, a 2D matrix symbol, a radio frequency tag and/or a NFC node, for example.

The surface 226 can include a printed surface 226. The printed surface 226 can include an advertisement for the charitable campaign. Additionally or alternatively, the surface 226 can include a label affixed to a kiosk apparatus configured for NFC.

The logotype 228 can include a stylized flower design, for example.

Still referring to FIG. 12, a context object 222 carrying context data for charitable donation, includes a surface 226 carrying a logotype 228 selected for user identification of the context object 222. A portable data carrier 224 is configured for interrogation by a mobile device 202 and carries non-transitory computer-readable access data structured for use by a mobile application to access context data on a server computer 218. The context data identifies one or more charitable campaigns for receiving a donation.

The structured data can include a data field carrying the context data, a data identifier configured to identify a structure of the data field, and an application identifier configured to identify a structure of the data field.

The structured data can include a tagged data field carrying the access data.

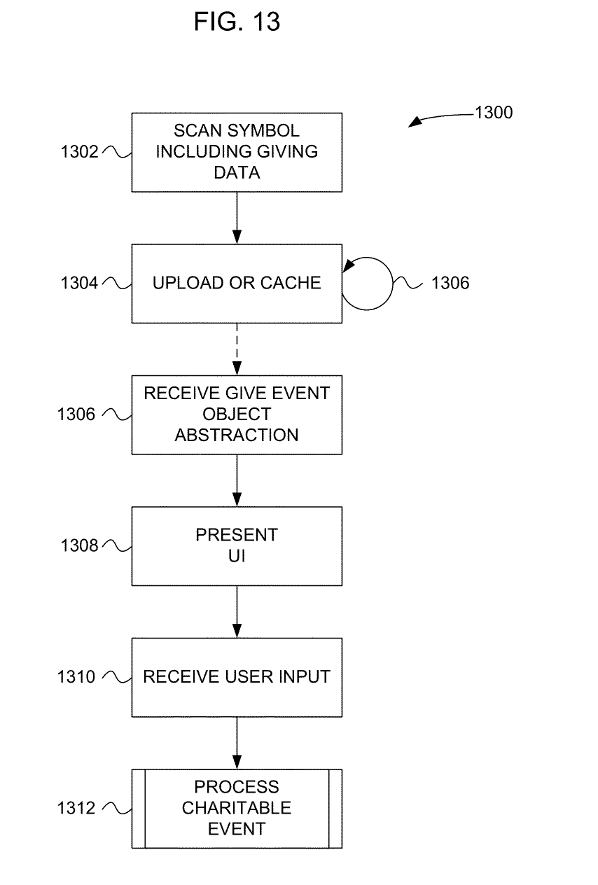

FIG. 13 is flow chart showing a method 1300 for scanning a machine-readable symbol to initiate a charitable giving event (donation), according to an embodiment. The method 1300 can be performed, for example, on a mobile device such as a smart phone. In step 1302, a scan-to-give symbol including a machine-readable symbol (also referred to as a “bar code symbol” or “symbol” herein) including at least one scan-to-give data field is scanned. The machine-readable symbol can take various forms. For example the bar code symbol can include a linear (1D) or a two-dimensional (2D) stacked or 2D matrix symbol. The machine-readable symbol can include color-encoded data.

The machine-readable symbol can be identified to a potential donor as a symbol positioned adjacent to a scan-to-give logotype associated with a scan-to-give organization (e.g., Hopela) or adjacent to a scan-to-give logo associated with a specific charitable organization. Alternatively, the scan-to-give logo and the machine readable symbol can be coextensive. For example a symbology made of units including address byte(s) associated with corresponding data byte(s) such as Supercode, can be distributed within an outline of the scan-to-give logo. Optionally, the scan-to-give symbol can be formed from glyphs printed on or in the background of the scan-to-give logo.

The scan-to-give symbol can include a structured data field, the structured data field including a data identifier, application identifier, or tagged data structure configured to convey structured data corresponding to giving data carried in symbol payload data.

The scan-to-give symbol includes charitable giving data. For example, the charitable giving data can include structured data. Structured data in a machine-readable symbol can include at least one pre-defined data identifier (DI) or application identifier (Al) associated with a specified data structure. Data associated with the structured data can be parsed according to rules present in application software loaded on the donor's mobile device, for example in a look-up table. Alternatively, the structured data can include a DI or Al associated with user-defined format (UDF) data. The UDF data can be parsed according to an algorithm or look-up table carried in a compatible application loaded on a mobile device.

Scan-to-give symbols can be posted at retail check-out stands, can be posted on self-adhesive labels, or can be included on postcards mailed to prospective donors, for example.

The scan-to-give data can take several forms. According to an embodiment, the scan-to-give data includes an identity of a charitable organization. The identity of the charitable organization can be presented in human readable characters adjacent to the scan-to-give symbol so that the donor is aware of the identity of the charitable organization. According to an embodiment, the scan to give data includes a donation amount. According to an embodiment, the scan-to-give data can include a conditional donation amount. For example “donate my change” can be encoded. Local discovery or other data transfer techniques can in real time or later correlate the scan-to-give event with the conditional donation amount. A scan-to-give data field can include an (NPO) identification. Additionally or alternatively, the scan-to-give data field includes a charitable campaign identification. Additionally or alternatively, the scan-to-give data field includes a serial number linked to one or more of an NPO identification or a charitable campaign identification. Additionally or alternatively, the scan-to-give donation context data field is assigned by a charitable event processing entity or a plurality of charitable event processing entities.

Proceeding to step 1304 the scan-to-give context data is uploaded to network-addressable server or cached locally. If the data is cached locally, a system utility or a portion to scan-to-give software can periodically retry to upload the scan-to-give data, as indicated by loop 1306.

In real time or shortly after giving, the donor can process the donation corresponding with the scan-to-give event. For example, a GUI can be presented on the donor's portable electronic device. Alternatively, the donor can access one or more scan-to-give events at a later time and/on another computer.

Proceeding to step 1306, a server including a scan-to-give processing engine or a local scan-to-give application loaded on the donor's portable device receives the scan-to-give data. A display engine can receive a giving event object abstraction linked to the giving data field.

Proceeding to step 1308, the donor is presented a GUI including the giving event object abstraction. The giving event object abstraction can include a scan-to-give logo along with a time, place, and amount of donation, for example. In another example, the giving event object abstraction can include an NPO or campaign profile (e.g., see FIG. 9).

Proceeding to step 1310, the GUI receives user (donor) input and/or presents information corresponding to the scan-to-give data. The donor can approve, cancel the donation, change the donation, verify or input the identity of the charity (for example in the case where the scan-to-give data corresponds to a campaign shared by multiple charities), select or approve a donation amount, select a recurrence of the contribution, select a privacy setting, rate the charity, determine a sub-charity (for example, by specifying a “cause” or use-of-funds), input or select a message to be included with the donation, and/or issue an explicit “Give” command to cause the contribution to be executed.

Optionally, receipt of the “Give” command can be omitted. Scanning of the scan-to-give symbol (or, equivalently, reading an RF tag, receiving NFC data, etc.) can operate as an affirmative act by the user, and the process can jump immediately to donation processing.

Proceeding to step 1312, the charitable event corresponding to the scanning event and one or more of the scan-to-give data field or received user input is processed. Processing can include transferring electronic funds from the donor's account to the charity. Processing can include transferring a portion of the donation to a scan-to-give infrastructure-providing organization.

The method can also include the charitable organization sending a thank you note to the donor, the donor “tweeting” or otherwise communicating their scan-to-give charitable donation to social media.

The scan-to-give support organization can record donations and send the donor a year-end statement that is valid for tax purposes. The donor can manage their scan-to-give support organization account. The scan-to-give support organization can record analytics regarding donors and campaigns. The scan-to-give support organization can sell advertising for display on its mobile application.

The method 1300 can be embodied as computer-executable instructions carried by non-transitory computer readable media configured to cause a computer or portable electronic device to execute the steps.

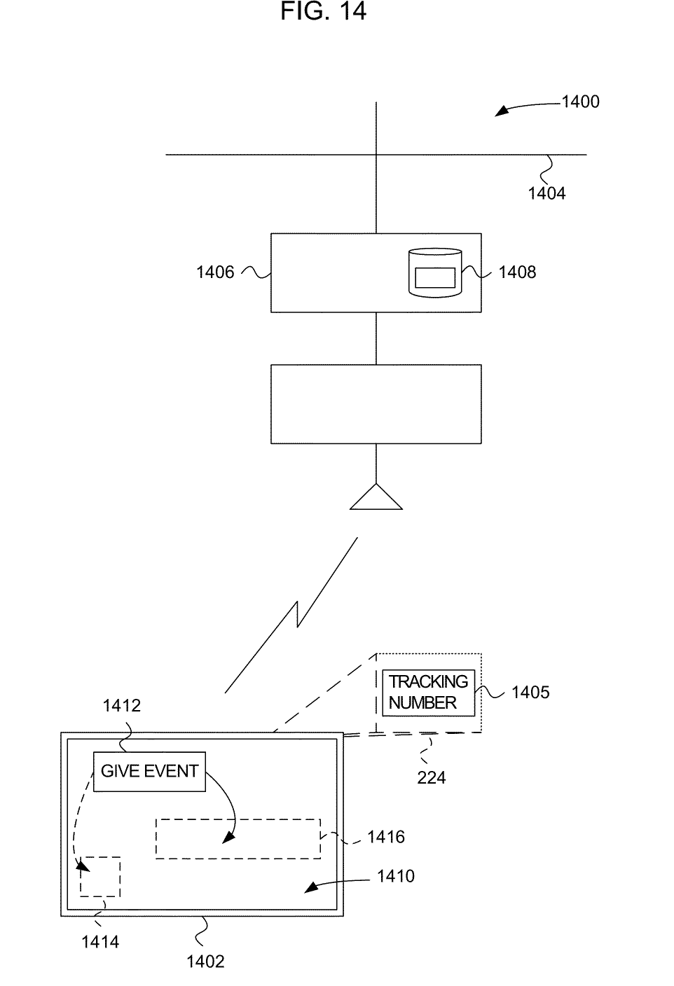

FIG. 14 is a diagram of a system 1400 for charitable event processing, according to an embodiment. A plurality of end devices 1402 are configured to scan a scan-to-give machine-readable symbol 224 including scan-to-give tracking data 1405. A network 1404 is configured to convey the scan-to-give tracking data and user identification or end device identification. A server 1406 includes an application 1408 configured to receive the giving event, receive tracking data, user, and/or end device identification.

The application 1408 can associate the giving event tracking data with a user account and execute or cause to be executed an account transfer from the user to a charitable organization selected by the user or included in the scan-to-give tracking data.

An end device 1402 application can present a GUI 1410 to a donor. The GUI can include giving event abstraction 1412. The user can drag and drop the giving event abstraction 1412 to a plurality of container abstractions 1414, 1416. Each container abstraction 1414, 1416 can correspond to an amount of secrecy or public disclosure that the user desires for the giving event. For example, a first container 1414 can include private donations where the user wishes to remain anonymous. A second container 1416 can include public donations or donations associated with a group campaign. For example, a giving event 1412 dragged into the second container 1416 can be logged on a group campaign website, for example for the purpose of encouraging other donors associated with the group campaign.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. A method for making a context-sensitive donation to a non-profit organization (NPO), comprising:
receiving user-initiation of a charitable donation software application on a mobile computing device via a user interface (UI);
operating mobile device hardware to obtain donation context data;
identifying a charitable campaign responsive to the donation context data;
displaying a charitable campaign profile to the user on a graphical display of the mobile device;
receiving a command via the UI to donate; and
processing a donation.

2. The method for making a context-sensitive donation to an NPO of claim 1, further comprising:
displaying a donation context mode selector on the graphical display of the mobile device; and
receiving user selection of the donation context mode via the UI;
wherein operating the mobile device hardware to obtain the donation context data includes operating mobile device hardware corresponding to the user-selected mode.

3. The method for making a context-sensitive donation to an NPO of claim 1, wherein operating the mobile device hardware includes executing computer instructions.

4. The method for making a context-sensitive donation to an NPO of claim 1, wherein operating the mobile device hardware includes capturing an image of physical indicia carrying the context data.

5. The method for making a context-sensitive donation to an NPO of claim 1, wherein operating the mobile device hardware includes operating one or more radios to obtain location data;
wherein the location data is at least a portion of the context data.

6. The method for making a context-sensitive donation to an NPO of claim 1, wherein operating the mobile device hardware includes operating a near field communication (NFC) apparatus to receive NFC data;
wherein the context data is carried by the NFC data.

7. The method for making a context-sensitive donation to an NPO of claim 1, wherein operating the mobile device hardware includes reading a mobile device clock circuit to determine a time; and
looking up the context data corresponding to the time.

8. The method for making a context-sensitive donation to an NPO of claim 1, wherein operating the mobile device hardware includes operating one or more radios to interrogate a radio frequency tag; and
writing radio frequency tag data to memory;
wherein the context data is carried by the radio frequency tag data.

9. The method for making a context-sensitive donation to an NPO of claim 1, wherein identifying a charitable campaign responsive to the donation context data further comprises:
transmitting the context data to a remote resource via radio transmitter hardware of the mobile device; and
receiving an identity of the charitable campaign from the remote resource via radio receiver hardware of the mobile device.

10. The method for making a context-sensitive donation to an NPO of claim 9, wherein the database query is performed on a campaign database carried by a memory circuit of the mobile device.

11. The method for making a context-sensitive donation to an NPO of claim 1, wherein identifying a charitable campaign responsive to the donation context data further comprises:
inputting the context data into a lookup table carried by memory hardware of the mobile device; and
receiving an identity of the charitable campaign from the lookup table.

12. The method for making a context-sensitive donation to an NPO of claim 1, wherein identifying a charitable campaign responsive to the donation context data further includes identifying a plurality of charitable campaign candidates corresponding to the context data; and
further comprising:
presenting the plurality of charitable campaign candidates on the graphical display of the mobile device; and
receiving selection of the charitable campaign from a user via the UI.

13. The method for making a context-sensitive donation to an NPO of claim 1, wherein displaying a campaign profile comprises displaying an NPO profile.

14. The method for making a context-sensitive donation to an NPO of claim 1, wherein displaying a campaign profile comprises displaying a profile predetermined by a particular NPO that benefits from a donation to the campaign.

15. The method for making a context-sensitive donation to an NPO of claim 1, wherein identifying a charitable campaign responsive to the donation context data includes identifying a plurality of charitable campaigns; and
further comprising:
presenting, to the user on the graphical display of the mobile device, a sequence of campaign profiles corresponding to the plurality of identified charitable campaigns.

16. The method for making a context-sensitive donation to an NPO of claim 1, further comprising:
displaying donation options to the user on the graphical display of the mobile device.

17. The method for making a context-sensitive donation to an NPO of claim 16, further comprising:
receiving a donation selection from the user via the UI;
wherein processing the donation comprises processing the selected donation.

18. The method for making a context-sensitive donation to an NPO of claim 1, wherein processing the donation is performed by transmitting data corresponding to a selected donation from the mobile device to a donation transaction server via cryptographic protocol communication.

19. The method for making a context-sensitive donation to an NPO of claim 1, further comprising:
displaying a thank you screen to the user on the graphical display of the mobile device;
displaying a social media sharing selection on the thank you screen of the mobile device;
receiving a social media sharing selection from the user via the UI of the mobile device; and
processing social media sharing corresponding to the donation.

20.-34. (canceled)

35. A system for context-sensitive donation to a non-profit organization (NPO), comprising:
a mobile device comprising:
a microprocessor;
a computer memory operatively coupled to the microprocessor and configured to cooperate with the microprocessor to execute computer instructions;
a radio circuit including at least one radio operatively coupled to the microprocessor and configured to communicate with a data network;
a graphical display operatively coupled to the microprocessor and configured to display graphical images responsive to microprocessor instructions; and
a user interface (UI) operatively coupled to the microprocessor and configured to receive user commands and output corresponding user command data for execution by the microprocessor; and
wherein the computer memory carries instruction data corresponding to a mobile software application for making a context-sensitive donation when the microprocessor executes the instruction data;
wherein the mobile software application includes instructions selected to cause the microprocessor to:
obtain donation context data;
transmit the donation context data to a server computer operatively coupled to the data network; and
receive data corresponding to one or more charitable campaign profiles associated with the context data by the server computer;
display a charitable campaign profile to the user on the graphical display;
receive a command from the user via the UI to donate; and
process the donation.

36. The system for context-sensitive donation to a NPO of claim 35, further comprising the server computer.

37. The system for context-sensitive donation to a NPO of claim 35, wherein the context data comprises location data corresponding to a particular location of the mobile device.

38. The system for context-sensitive donation to a NPO of claim 35, wherein the context data comprises data carried by a portable data carrier available in an environment of the mobile device.

39. The system for context-sensitive donation to a NPO of claim 38, wherein the context data comprises structured data.

40. The system for context-sensitive donation to a NPO of claim 35, wherein the memory includes computer instructions selected to cause the microprocessor to receive a context data mode selection from the user via the UI; and
wherein capturing the donation context data includes capturing and decoding the machine-readable symbol.

41. The system for context-sensitive donation to a NPO of claim 40, wherein capturing the donation context data further comprises:
converting decoded accessing the donation context data as a function of the captured and decoded machine-readable symbol data.

42. The system for context-sensitive donation to a NPO of claim 40, wherein receiving the context data mode selection from the user includes receiving a command to capture an image; and
wherein capturing the donation context data further comprises:
capturing the image;
converting the image to image data; and
converting the image data to the donation context data.

43. A non-transitory computer readable medium carrying computer executable instructions selected to cause a mobile device to execute steps, comprising:
obtaining donation context data;
identifying a charitable campaign responsive to the donation context data;
displaying a charitable campaign profile to a user;
receiving a command to donate; and
transmitting data corresponding to the donation command.

44. The non-transitory computer readable medium carrying computer executable instructions of claim 43, wherein the instructions are further selected to cause the mobile device to execute steps comprising:
displaying a donation context mode selector; and
receiving user selection of the donation context mode;
wherein obtaining the donation context data includes operating mobile device hardware corresponding to the user-selected mode.

45. The non-transitory computer readable medium carrying computer executable instructions of claim 43, wherein the instructions selected to operate mobile device hardware to perform the steps.

46. The non-transitory computer readable medium carrying computer executable instructions of claim 45, wherein operating the mobile device hardware includes capturing an image of physical indicia carrying the context data.

47. The non-transitory computer readable medium carrying computer executable instructions of claim 45, wherein operating the mobile device hardware includes operating one or more radios to obtain location data; and
wherein the location data is at least a portion of the context data.

48. The non-transitory computer readable medium carrying computer executable instructions of claim 45, wherein operating the mobile device hardware includes operating a near field communication (NFC) apparatus to receive NFC data;
wherein the context data is carried by the NFC data.

49. The non-transitory computer readable medium carrying computer executable instructions of claim 45, wherein operating the mobile device hardware includes reading a mobile device clock circuit to determine a time; and
wherein the instructions are further selected to cause the mobile device to look up context data corresponding to the time.

50. The non-transitory computer readable medium carrying computer executable instructions of claim 45, wherein operating the mobile device hardware includes operating one or more radios to interrogate a radio frequency tag; and
write radio frequency tag data to memory;
wherein the context data is carried by the radio frequency tag data.

51. The non-transitory computer readable medium carrying computer executable instructions of claim 43, wherein identifying a charitable campaign responsive to the donation context data further comprises:
transmitting the context data to a remote resource via radio transmitter hardware of the mobile device; and
receiving an identity of the charitable campaign from the remote resource via radio receiver hardware of the mobile device.

52. The non-transitory computer readable medium carrying computer executable instructions of claim 43, wherein identifying a charitable campaign responsive to the donation context data further comprises:
inputting the context data into a lookup table carried by memory hardware of the mobile device; and
receiving an identity of the charitable campaign from the lookup table.

53. The non-transitory computer readable medium carrying computer executable instructions of claim 43, wherein identifying a charitable campaign responsive to the donation context data further includes identifying a plurality of charitable campaign candidates corresponding to the context data; and
wherein the steps further comprise:
presenting the plurality of charitable campaign candidates to the user; and
receiving selection of the charitable campaign from the user.

54. The non-transitory computer readable medium carrying computer executable instructions of claim 43, wherein displaying a campaign profile comprises displaying a nonprofit organization profile.

55. The non-transitory computer readable medium carrying computer executable instructions of claim 43, wherein displaying a campaign profile comprises displaying a profile predetermined by a particular nonprofit organization that benefits from a donation to the campaign.

56. The non-transitory computer readable medium carrying computer executable instructions of claim 43, wherein identifying a charitable campaign responsive to the donation context data includes identifying a plurality of charitable campaigns; and
wherein the steps further comprise:
presenting, to the user a sequence of campaign profiles corresponding to the plurality of identified charitable campaigns.

57. The non-transitory computer readable medium carrying computer executable instructions of claim 43, wherein the steps further comprise:
displaying donation options to the user.

58. The non-transitory computer readable medium carrying computer executable instructions of claim 57, wherein the steps further comprise:
receiving a donation selection from the user; and
wherein transmitting data corresponding to the donation command includes transmitting the selected donation.

59. The non-transitory computer readable medium carrying computer executable instructions of claim 43, wherein transmitting data corresponding to the donation command includes transmitting data corresponding to the donation from the mobile device to a donation transaction server via cryptographic protocol communication.

60. The non-transitory computer readable medium carrying computer executable instructions of claim 43, wherein the steps further comprise:
displaying a thank you screen to the user on a graphical display of the mobile device;
displaying a social media sharing selection on the thank you screen of the mobile device;
wherein the steps further comprise:
receiving a social media sharing selection from the user; and
processing social media sharing corresponding to the donation.

61.-88. (canceled)
